(19) United States
(12) Patent Application Publication
(10) Pub. No.: US 2001/0006693 A1
(43) Pub. Date: Jul. 5, 2001

(54) Device and method for selling foodstuffs

(76) Inventors: Jacobus Petrus Maria Dessing, La Cruquius (NL); Mattijn Godewijn DeGraaf, Bj Leiden (NL); Pieter Adriaan Oosterling, Nieuw-Vennep (NL)

Correspondence Address: ST. ONGE STEWARD JOHNSTON & REENS, LLC, 986 BEDFORD STREET, STAMFORD, CT, 06905-5619, US

(21) Appl. No.: 09/766,706

(22) Filed: Jan. 22, 2001

Related U.S. Application Data
(63) Continuation of application No. PCT/NL99/004433, filed on Jul. 7, 1999.

(30) Foreign Application Priority Data
Jul. 22, 1998 (NL) 1009715

(51) Int. Cl. A47J 43/18

(52) U.S. Cl. 426/231; 99/426

(57) ABSTRACT

This invention relates to a device for selling foodstuffs. Product carriers are stored on a storage rack in a cabinet with a cooled atmosphere. A stock of foodstuff, such as meat products, is present on the product carriers. An ordered quantity is separated from this foodstuff by separating means, such as a cutting machine, and is then packaged. The invention relates to the removal of product carriers from the cabinet and the introduction of product carriers into the cabinet, by making use of a filling station.

This is a continuation of pending International Application PCT/NL99/00433 filed on Jul. 7, 1999, which designates the United States.

The invention relates to a device according to the preamble of claim 1. A device of this nature is known from U.S. Pat. No. 5,520,941. The drawback of the known device is that it is necessary to stop dispensing foodstuffs when the device is being stocked up. This is because stocking up involves taking empty product carriers out of the storage rack and replacing them with product carriers which are filled with foodstuff. In doing so, the cabinet has to be opened, so that the interior of the cabinet is accessible. During this time, the conveyor means are stopped and blocked, since otherwise the operator can come into contact with the moving conveyor means, resulting in the possibility of injury. While the conveyor means are at a standstill and the cabinet is open, the device cannot be used, which is undesirable. In order to prevent this drawback, the device is designed according to the characterizing part of claim 1. Since the cabinet remains closed, the conveyor means can continue to function more or less without interference in any situation while exchanging empty product carriers and filled product carriers.

According to a refinement, the device is designed according to claim 2. As a result of only a small part of the wall being opened when filling the cabinet, the cooled atmosphere in the cabinet is not lost, resulting in a considerable energy saving and limiting condensation.

According to a further refinement, the device is designed according to claim 3. By making the opening no larger than the smallest dimensions of a product carrier, it is possible to introduce the product carrier with the foodstuff into the cabinet while scarcely any cooled air escapes.

According to one embodiment of the invention, it is designed according to claim 4. The possibility of blocking the introduction of a filled product carrier prevents a fault from occurring if there is a failure to satisfy all the conditions required for introduction, such as inputting of the correct data and the correct position of the conveyor means.

According to one embodiment of the invention, it is designed according to claim 5. This makes it possible to prevent the conveyor means from colliding with an objet which has been inserted into the cabinet, such as for example a hand or arm, thus preventing injury.

According to one embodiment of the invention, it is designed according to claim 6. In this way, it is easily possible to transmit the data of a product carrier to the control system, avoiding errors.

According to one embodiment of the invention, it is designed according to claim 7. By providing the separating means with a buffer, it is possible for the separating means to operate without interruption and without having to wait for the supply or removal of product carriers by the conveyor means. It is also possible for the conveyor means to supply and take away product carriers while the separating means are busy with one product carrier. This makes the device more efficient in use.

According to one embodiment of the invention, it is designed according to claim 8. In this way, it is possible, at the same time, to maintain a low temperature in the cabinet, which is beneficial for the cutting properties of the foodstuff, and a high relative humidity, preventing the stored foodstuff from drying out. The invention also comprises a method for stocking up a device according to the invention, as described in claim 9. By using the conveyor device in the cabinet for taking the product carriers out of the cabinet, it is possible to achieve a rapid and efficient method.

According to a refinement of the method, the latter is carried out according to claim 10. By moving a filled product carrier to the storage rack and the storage location using the conveyor means, it is simple to fill the device.

According to a further refinement of the method, it is carried out according to claim 11. By providing the control unit with information relating to the introduced product carrier and the foodstuff during the introduction of a product carrier, errors relating to the characteristics of the articles present in the device are eliminated as far as possible.

The invention is illustrated below with reference to a number of exemplary embodiments and with the aid of a drawing, in which:

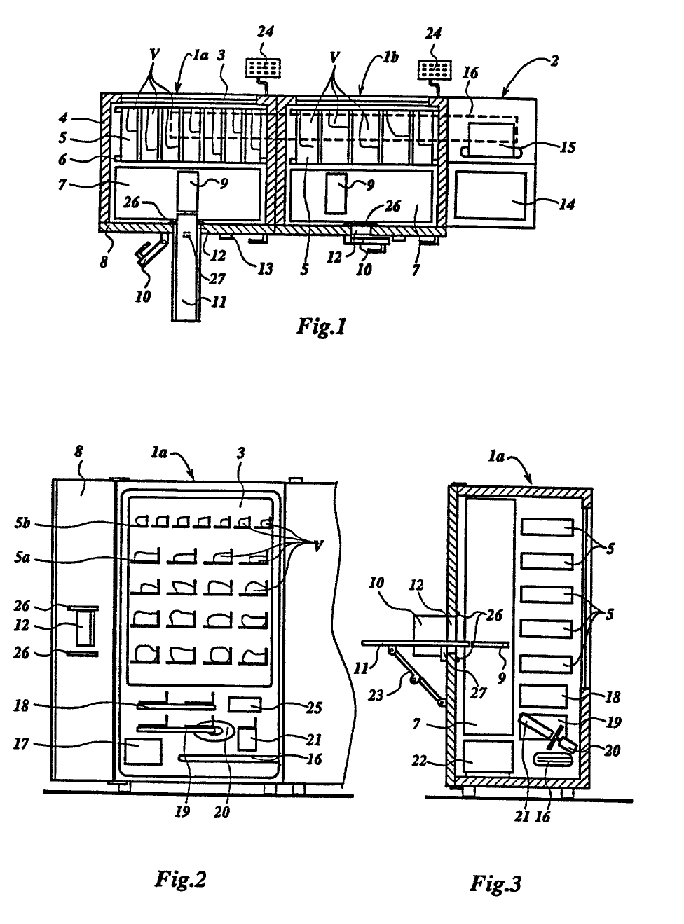

FIG. 1 shows a diagrammatic plan view of a cabinet for dispensing foodstuff, such as meat products,

FIG. 2 shows the rear view, with the door open, of the cabinet shown in FIG. 1, and

FIG. 3 shows a diagrammatic cross section through the cabinet shown in FIG. 1.

The figures provide a diagrammatic representation of the most important components, which may be realized in a wide variety of manners by the person skilled in the art. Details such as pipes, attachment means, hinges and the like are indicated purely incidentally.

FIG. 1 shows a device for dispensing meat products as is known from U.S. Pat. No. 5,520,941. A cabinet la has insulating walls 4, an insulting door 8 and an insulating window 3. The top side and underside of the cabinet are also insulated, and all further necessary measures are taken, so that a temperature of approximately −2° C. can be maintained in the cabinet. The internal walls of the cabinet and floor are of smooth design, so that they are easy to clean when the equipment has been removed from the cabinet.

A storage rack 6 is disposed in the cabinet la. Product carriers 5 are located next to and above one another in the storage rack 6, in such a manner that the foodstuff V which is attached to the product carriers 5 can be seen through the window 3. A conveyor device 7 is positioned parallel to the storage rack 6, with a carriage 9 by means of which the product carriers 5 can be taken out of the storage rack 6 and can be conveyed to a cutting device 20 (cf. in this respect the description associated with FIG. 2). Under the influence of a control unit 17 (cf. FIG. 2), the carriage 9 moves between the various positions in the cabinet 1a. Foodstuff V which is to be cut off, such as for example meat products, is positioned on the product carriers 5.

The door 8 of the cabinet la is provided with an opening 12 which can be closed off by means of an insulating hatch 10. An introduction carriage 11 may be arranged on the door 8 at the location of the opening 12, with the aid of which carriage product carriers 5 can be taken from the carriage 9 and, when they have been filled, placed back on the carriage 9. The introduction carriage 11 is provided with a blocking means 27, which is coupled to the control unit 17. In order to transmit the data of a product carrier 5 which is to be introduced and of the foodstuff V located thereon, or in particular the meat products, to the control units 17, a keyboard 13 is arranged next to the opening 12. A detector 26 for detecting objects which are inserted through the opening 12 into the cabinet and therefore into the path of the conveyor device 7 is arranged on the inside of the door 8, in the vicinity of the opening 12. If objects are detected, the control unit 17 is notified of this and the conveyor device 7 is stopped. The detector 26 may be designed as a light screen, or possibly as a door with a switch.

In the device shown in FIG. 1, two more or less identical cabinets 1a and 1b are shown, with a dispensing station 2 next to them. A person wishing to order foodstuff V gives his/her order to the control unit 17 via a control panel 24. Then, the foodstuff V, such as for example meat products, is cut off, for example in the cabinet la, and is conveyed to the dispensing station 2 via a conveyor belt 16. The meat products are then packaged in a packaging unit 14 and are delivered to the user via a dispensing chute 15.

FIG. 2 shows the rear side of the cabinet 1a, with the door 8 open and the conveyor device 7 removed. This is easy, since the latter is on wheels. It is possible to see the product carriers 5 which lie in storage racks 6 (not indicated) with the foodstuff V thereon. Narrow product carriers 5b are located in the top of the cabinet, and wide product carriers 5a are located in the bottom of the cabinet.

The cutting device 20 is positioned beneath the storage rack 6 with the product carriers 5, and is shown holding a product carrier 5 which has been moved into a cutting position 21. In connection with cleaning work, it is necessary for it to be possible to take the cutting device 20 out of the cabinet, and to this end the cutting device is on wheels. In order to enable the conveyor device 7 to supply or take away product carriers 5 during the cutting operation, the cutting device 20 is provided with an introduction buffer 18 with one or two storage positions for product carriers 5, a removal buffer 19, likewise with one or two positions for the product carrier 5, and a manipulator 25 for putting the product carriers 5 into the cutting device 20 or removing them therefrom. The conveyor device 7 places a product carrier 5 into the introduction buffer 18, and then this product carrier is placed into the cutting device 20 by the manipulator 25, and the desired quantity of foodstuff V is cut off. Then, the product carrier 5 is placed into the removal buffer 19 by the manipulator 25. The conveyor device 7 moves the product carrier 5 out of the removal buffer 19 to its storage position or, in the event of a repeat order, back into the introduction buffer 18. The foodstuff which has been cut off is conveyed to the dispensing station 2 by the conveyor belt 16.

In another embodiment, the introduction buffer 18 and the removal buffer 19 may also be combined to form, for example, a paternoster, by means of which the product carriers 5 are conveyed in steps towards and away from cutting position 21 and are placed in the cutting position, for example by the manipulator 25.

FIG. 3 shows a cross-sectional view through the cabinet 1a, with the carriage 9 of the conveyor device 7 located in front of the introduction carriage 11, so that a product carrier 5 can be introduced. The introduction carriage 11 is supported by a support 23. A cooling unit 22, with which the temperature in the cabinet can be kept at approximately −2° C., is diagrammatically depicted beneath the conveyor device 7. In order to allow the interior of the cabinet la to be cleaned, the cooling unit 22 is on wheels. If appropriate, the cooling unit is provided with a fan and with means for removing or preventing frost. Since, during normal use of the device, the door 8 can remain closed, as the foodstuff V is introduced via the small opening 12, it is possible for the capacity of the cooling unit 22 to be limited. Since a low temperature −2° C. is maintained in the cabinet 1 with a high atmospheric humidity, the temperature difference between the cooling surface of the cooler 22 and the cabinet must be limited to a few degrees Celsius. The cooling surface of the cooler 22 must therefore be very large and is at least 1.5 times to twice the size of the surface of the walls of the cabinet.

The device is preferably filled during normal operation. After the hatch 10 has been opened and the introduction carriage 11 has been positioned in front of the opening 12, the operator calls up a product carrier 5 which is to be filled by inputting a command to the control unit 17. The carriage 9 then positions an empty product carrier 5 in front of the introduction carriage 11, under the influence of the control unit 17. The operator removes this product carrier 5 from the cabinet 1a, if appropriate using a special removal tool, after which the conveyor device 7, following this brief interruption, can again operate normally, and the dispensing of foodstuff V can continue without interruption.

After the operator has filled the product carrier 5, the latter is placed on the introduction carriage 11. The introduction carriage 11 is provided with a blocking means 27 which is operated by the control unit 17, so that the product carrier 5 cannot be pushed into the cabinet if the conveyor device 7 is not ready and, for example, the carriage 9 is at the correct position. Then, the keyboard 13 is used to input which foodstuff V has been placed on the product carrier 5, and also, for example, its price and any other relevant information. The width of the product carrier 5 is also input, so that it is possible to monitor whether a storage position for this width is still free in the cabinet. After this data has been processed in the control unit 17, the conveyor device 7 is activated. After the carriage 9 has moved to the correct position, the introduction blocking is eliminated and the product carrier 5 can be introduced into the cabinet la. In the process, the width of the product carrier is also checked, in order to ensure that the data were input correctly and in order to prevent faults.

Numerous alternative designs are possible in addition to the design described above.

In the design shown, the introduction carriage 11 is arranged on the rear side of the cabinets 1a and 1b, with the conveyor device 7 positioned between the introduction carriage 11 and the storage rack 6. However, it is also possible to arrange the introduction carriage 11 on the front side and, for example, to allow it to form part of the storage rack 6. In this case, an opening is made on the front side of the cabinet for introduction and removal of the product carriers 5, the latter being pushed directly into the introduction carriage in the storage rack 6.

An alternative design involves integrating the hatch 10, the introduction carriage 11 and the support 23, so that the hatch 10 is at the same time the support for the introduction of product carriers and, for example, the hinges are arranged on the underside of the hatch 10.

A cutting device 20 is incorporated in the exemplary embodiment described above. In a situation in which, for example, meal components, such as vegetables and salads and the like are stored in a cabinet 1, different separating means will be arranged in the cabinet instead of a cutting device 20. In this case, for example, a plastic tray, which is supplied with suitable means, is filled by means of an automatic scoop device.

The cooling unit 22 described above, which is positioned in the bottom of the cabinet as a separate module, may also be positioned on the cabinet. It is also possible, for example, to design the walls as cooling plates, and if appropriate flash evaporators may also be used, or else the cooling system may be arranged in the top of the cabinet. In addition to cooling, it is also possible to provide other measures in order to obtain a suitable atmosphere in the cabinet 1. Consideration must be given to means for controlling the humidity or means for supplying special gases, such as carbon dioxide, alcohol vapours and the like.

The control unit 17 is shown as a module in the bottom of the cabinet 1a. However, it is also possible to accommodate the control unit in a separate switch box which is connected to the various components of the device by means of cables. The control unit interacts, in a known way, with the sensors, motors, encoders and the like which are present in the cabinets 1a, 1b and 2 in order to correctly execute the orders input on the control panels and all further operations which are required for maintenance of the device, such as for example the above-described operation of filling the device.

In addition to the above-described configuration with two cabinets and one dispensing station, it is, of course, also possible to use other configurations, depending on the conditions which prevail in the shop area.

1. Device for selling foodstuffs (V), comprising at least one cabinet (1a, 1b), each with heat-insulating walls (4) with, inter alia, a door (8), the cabinet holding, inter alia, a storage rack (6) for product carriers (5) with foodstuff (V), means (22) for keeping the interior of the cabinet (1) at the storage temperature, separating means (20) for separating a quantity of the foodstuff (V) present on a product carrier (5), and conveyor means (7, 9) for conveying the product carriers (5) between the storage rack (6) and the separating means (20), and the device being provided with control means (17), inter alia for controlling the separating means (20) and conveyor means (7, 9), characterized in that the device comprises means (11) for removing and introducing product carriers (5) from and into the closed cabinet

2. Device according to claim 1, characterized in that the removal and introduction means comprise a filling station (11) having an opening (12) through the insulating wall (4).

3. Device according to claim 2, characterized in that the dimensions of the opening (12) substantially correspond to the smallest dimensions of a product carrier (5) filled with foodstuff (V).

4. Device according to one of the preceding claims, characterized in that the removal and introduction means (11) are provided with blocking means (27) which are coupled to the control unit (17) and which can be used to block the introduction of a product carrier (5) into the cabinet (1).

5. Device according to one of claims 2-4, characterized in that in the vicinity of the opening (12) there are means (26), which are coupled to the control unit (17), for detecting the presence of objects in the path of the conveyor means (7).

6. Device according to one of the preceding claims, characterized in that the removal and introduction means (11) are provided with a keyboard (13) for inputting data to the control unit (17).

7. Device according to one of the preceding claims, characterized in that the separating means (20) are provided with at least one buffer (18, 19) for storage of product carriers (5) which have been supplied and/or not yet taken away by the conveyor means (7, 9).

8. Device according to one of the preceding claims, characterized in that the means (22) for keeping the interior of the cabinet (1) at the storage temperature comprise a cooler with a cooling surface which is at least 1.5 times to twice as large the surface of the walls (28) of the cabinet (1)

9. Method for stocking up a device according to one of claims 1-8, characterized in that the conveyor means (7, 9) take a product carrier (5) to be filled from the storage rack (6) and convey it to the removal and introduction means (11).

10. Method for stocking up a device according to one of claims 1-8, characterized in that the conveyor means (7, 9) convey a filled product carrier (5), after it has been introduced into the cabinet (1), to a position in the storage rack (6).

11. Method according to claim 10, characterized in that, before the product carrier (5) is introduced into the cabinet (1), the data which are necessary for the device to function, such as dimensions thereof and the characteristics of the foodstuff (V) which is present on the product carrier (5), are transmitted to the control means (17), for example with the aid of a keyboard (13).
